(19) United States
(12) Patent Application Publication
(10) Pub. No.: US 2007/0219982 A1
(43) Pub. Date: Sep. 20, 2007

(54) SYSTEMS AND METHODS FOR ELECTRONIC SEARCHING OF AUTOMOTIVE PARTS DATABASE

(76) Inventors: James Piper, Corona Del Ula, CA (US); David Brumley, San Diego, CA (US); Jason McNeeley, Placentia, CA (US); Clark Limbacher, Livermore, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/539,077

(22) Filed: Oct. 5, 2006

Related U.S. Application Data
(60) Provisional application No. 60/723,895, filed on Oct. 5, 2005.

(51) Int. Cl. G06F 17/30

(52) U.S. Cl. 707/5

(57) ABSTRACT

Systems and methods for preparing electronic searches are disclosed. In situations involving large number of items for many models of products, searches can be burdensome to the database. Moreover, variations in user skills can make many search requests inefficient and even meaningless. In one embodiment, search requests from users are prepared at a web server so as to form a more focused and meaningful search query for the database. Because such computing resource investments can be made at one or more servers, burden of heavy search loads can be distributed to the servers from the database. Various techniques for forming search queries can include translating abbreviations, nomenclatures, and misspellings. Moreover, use of standardized words allows for more efficient searches. In one embodiment, large number of automobile parts can be searched efficiently by prioritized matching of vehicle model information and part information from a search request in forming the search query.

### PRIORITY CLAIM

This application claims the benefit of priority under 35 U.S.C. § 119(e) of U.S. Provisional Application No. 60/723,895 filed on Oct. 5, 2005 and titled DEVICE AND METHOD FOR TAXONOMICALLY DESCRIBING AND SEARCHING AUTOMOTIVE PARTS, the entirety of which is incorporated herein by reference.

### BACKGROUND

1. Field

The present disclosure generally relates to electronic searching techniques, and more particularly, to systems and method for performing searches involving large number of parts for many different models of a product.

2. Description of the Related Art

Many electronic searches are text searches, in that the input terms are compared with texts associated with items being searched. For example, the items being searched can be part of an electronic catalog, and each item can have a brief description. There are many situations where such searching can be burdensome to both the users and to the catalog database itself.

For example, if there are large number of users with wide range of knowledge, search inputs may or may not be meaningful. The database, trying to accommodate all of such search request, may become bogged down in the process, thereby reducing the overall searching experience. If the database is associated with a business such as an online merchant, the level of business may be affected detrimentally.

Some online merchants employ drill-down processes to help identify the right item being sought. Such processes, however, can be relatively tedious and time-consuming for the users.

### SUMMARY

At least some of the foregoing problems can be addressed by various embodiments of systems and methods for preparing electronic searches. In one embodiment, search requests from users are prepared at a web server so as to form a more focused and meaningful search query for the database. Because such computing resource investments can be made at one or more servers, burden of heavy search loads can be distributed to the servers from the database. Various techniques for forming search queries can include translating abbreviations, nomenclatures, and misspellings. Moreover, use of standardized words allows for more efficient searches. In one embodiment, large number of automobile parts can be searched efficiently by prioritized matching of vehicle model information and part information from a search request in forming the search query.

One embodiment of the present disclosure relates to a method for searching an electronic catalog for automobile parts. The method includes receiving a search request having one or more terms that describe or attempt to describe an automobile part. The method further includes comparing the one or more terms with a standard vocabulary. The method further includes identifying one or more matched words, with each of the one or more matched words being a part of the standard vocabulary and corresponding to at least one of the one or more terms, such that the one or more matched words are used for conducting a search for information about the automobile part in an electronic database.

In one embodiment, the method further includes identifying one or more part descriptions that include at least some of the one or more matched words. In one embodiment, each of the one or more part descriptions includes all of the one or more matched words. In one embodiment, the standard vocabulary is formed based on words from the part descriptions.

In one embodiment, the comparison includes translating abbreviations, alternate nomenclatures, and misspellings to corresponding words prior to comparison with the standard vocabulary. In one embodiment, the comparison includes performing a look-ahead on the one or more terms to identify terms that should be treated together as a single term. In one embodiment, every word in the standard vocabulary is substantially unique so as to reduce likelihood of the one or more matched words having more than one of same word. In one embodiment, the identification of one or more matched words further includes obtaining identity or possible identities of the automobile so as to further narrow the search for information about the automobile part.

Another embodiment of the present disclosure relates to a system for searching an electronic catalog for automobile parts. The system includes a standard vocabulary component having a plurality of standardized words with respect to information in an electronic database about parts for automobiles. The system further includes a processor configured so as to receive a search request having one or more terms that describe or attempt to describe an automobile part. The processor is further configured so as to compare the one or more terms with the plurality of standardized words. The processor is further configured so as to identify one or more matched words, with each of the one or more matched words being a part of the plurality of standardized words and corresponding to at least one of the one or more terms, such that the one or more matched words are used for conducting a search for information about the automobile part in the electronic database.

In one embodiment, the standard vocabulary component and the processor reside on a server that is separate from electronic database, such that search queries sent to the electronic database are standardized and narrowed at the server to thereby make the search for information more efficient. In one embodiment, the system further includes a description component having a plurality of automobile-parts descriptions that include substantially all of the one or more matched words. In one embodiment, the plurality of standardized words are based on words from the automobile-parts descriptions. In one embodiment, every one of the plurality of standardized words is substantially unique so as to reduce likelihood of the one or more matched words having more than one of same word.

In one embodiment, the system further includes an editor component configured so as to allow an editor to view taxonomical structure of selected one or more words found in the plurality of automobile-parts descriptions.

In one embodiment, the system further includes a translation component having common abbreviations, alternate nomenclatures, and misspellings so as to allow translations of the one or more terms.

In one embodiment, the standard vocabulary component includes a first vocabulary for identifying models of automobiles, and a second vocabulary for identifying parts for automobiles. In one embodiment, the first and second vocabularies are separate vocabularies. In one embodiment, the first and second vocabularies reside in a local memory of a same server. In one embodiment, the processor performs the identification separately for the automobile part and for the model corresponding to the automobile part.

Yet another embodiment of the present disclosure relates to a method for searching an electronic catalog for parts that depend on models of products. The method includes receiving a search request having one or more terms that describe a model of a product and a part for the product. The method further includes determining which of the one or more terms are for describing the model, and which are for describing the part. The method further includes identifying one or more standardized words based on the model-terms. The method further includes identifying one or more standardized words based on the part-terms. The method further includes forming a search query based on the one or more standardized model-words and the one or more standardized part-words. The method further includes transmitting the search query to an electronic database for conducting a search for information about the part for the product.

In one embodiment, the product includes an automobile.

Yet another embodiment of the present disclosure relates to a system for searching an electronic catalog for parts that depend on models of products. The system includes a first standard vocabulary having words for identifying product models. The system further includes a second standard vocabulary having words for identifying product parts. The system further includes a processor configured so as to receive a search request having one or more terms that describe a model of a product and a part for the product. The processor is further configured so as to determine which of the one or more terms are for describing the model, and which are for describing the part. The processor is further configured so as to identify one or more standardized words based on the model-terms. The processor is further configured so as to identify one or more standardized words based on the part-terms. The processor is further configured so as to form a search query based on the one or more standardized model-words and the one or more standardized part-words. The processor is further configured so as to transmit the search query to an electronic database for conducting a search for information about the part for the product.

In one embodiment, the product includes an automobile.

Yet another embodiment of the present disclosure relates to an apparatus having means for receiving a search request having one or more terms that describe or attempt to describe an automobile part. The apparatus further includes means for comparing the one or more terms with a standard vocabulary. The apparatus further includes means for identifying one or more matched words, with each of the one or more matched words being a part of the standard vocabulary and corresponding to at least one of the one or more terms, such that the one or more matched words are used for conducting a search for information about the automobile part in an electronic database.

Yet another embodiment of the present disclosure relates to an apparatus having means for receiving a search request having one or more terms that describe a model of a product and a part for the product. The apparatus further includes means for determining which of the one or more terms are for describing the model, and which are for describing the part. The apparatus further includes means for identifying one or more standardized words based on the model-terms. The apparatus further includes means for identifying one or more standardized words based on the part-terms. The apparatus further includes means for forming a search query based on the one or more standardized model-words and the one or more standardized part-words. The apparatus further includes means for transmitting the search query to an electronic database for conducting a search for information about the part for the product.

Yet another embodiment of the present disclosure relates to a method for method for searching an electronic database for possible applications of automobile parts. The method includes receiving a search request from a user, and forming a search query, where the search query includes a model identifier and one or more part identifiers. The method further includes determining possible applications by forming combinations of the one or more part identifiers with one or more attributes of the model identifier. The method further includes providing the possible applications to the user. In one embodiment, the possible applications includes at least one attribute that is not specified by the user.

Yet another embodiment of the present disclosure relates to a method for configuring a database server for an automobile parts catalog. The method includes providing a list of identifiers for automobile parts. The method further includes providing a list of identifiers for attributes of automobile models. The method further includes forming an index of selected combinations of the identifiers for parts and attributes. The method further includes providing the index on the database server so that the index provides addresses of database entries corresponding to the identifiers for parts or attributes.

In one embodiment, the selected combinations are determined based on a likelihood of a search for the parts or attributes. In one embodiment, the selected combinations are formed by excluding redundancies of combinations of the parts and attributes.

### BRIEF DESCRIPTION OF THE DRAWINGS

FIG. 1 shows a block diagram of one embodiment of a configuration where a search component can facilitate searching of a database by a user;

FIG. 2 shows that in one embodiment, the search component can be part of a web page server interacting with a client and a database server;

FIG. 3 shows that in one embodiment, the web page server can be a merchant website server servicing purchasers, and the database server can be a merchant database server for a catalog database;

FIG. 4 shows that in one embodiment, the merchant website can include an automobile parts merchant website server to facilitate searching of automobile parts in one or more catalogs stored in one or more databases;

FIG. 5 shows that in one embodiment, the search component can reside on a server to provide an interface between a user and a database during a searching process;

FIG. 6 shows that in one embodiment, the search component can include dictionaries that define various abbreviations, nomenclatures, and/or misspellings, list standard vocabulary words, and list descriptions useful for identifying automobile parts;

FIG. 7 shows that in one embodiment of a process that can be performed by the search component;

FIG. 8 shows examples results at various stages of the process of FIG. 7 for an example search input obtained from a user;

FIG. 9 shows one embodiment of a process that can be a more specific example of the process of FIG. 7;

FIG. 10 shows one embodiment of a process that can be used by the process of FIG. 9;

FIG. 11 shows one embodiment of a process that can be a more specific example of the process of FIG. 9;

FIG. 12A shows one embodiment of a dictionary having example entries that provide translations of abbreviations, nomenclatures, and/or misspellings for terms relating to automobile parts;

FIG. 12B shows one embodiment of a dictionary having example entries that provide translations of abbreviations, nomenclatures, and/or misspellings for terms relating to automobile models;

FIG. 13 shows one embodiment of a standard vocabulary having example entries that provide standard words relating to automobile parts and/or models;

FIG. 14A shows one embodiment of a description dictionary having example entries, where such entries provide descriptions of automobile parts and their corresponding assigned identifiers;

FIG. 14B shows one embodiment of a description dictionary having an example entry, where such entries provide descriptions of automobile models and their corresponding assigned identifiers;

FIG. 15 shows by way of example how an example search request from a user can be processed locally on a server to generate a search query for sending to a database, where such pre-database processing can provide a more meaningful and efficient searching for automobile parts;

FIG. 16A shows an example result of the example search performed in FIG. 15;

FIG. 16B shows that in one embodiment, search results can be refined further;

FIG. 17 shows that in one embodiment, various dictionaries and vocabularies can reside locally on plurality of servers, and maintenance of such dictionaries and vocabularies can be coordinated by a master server so as to provide uniformity;

FIG. 18 shows one embodiment of an example process that can maintain the standard vocabulary based on an updated description dictionary;

FIG. 19 shows that in one embodiment, the master server of FIG. 17 can be configured to provide various functionalities for maintaining the plurality of servers;

FIG. 20 shows an example functionality of the master server of FIG. 19, where usage of selected terms can be viewed in a taxonomically organized manner so as to provide a visual tool for an editor maintaining the plurality of servers;

FIG. 21 shows that in one embodiment, catalog databases can be searched for applications possible for the search query formed from user input;

FIG. 22 shows one embodiment of a process that can be performed to determine possible application(s) that are not necessarily limited to the user input;

FIG. 23 shows one embodiment of a process that can be performed on a user-interfacing server to provide the possible application(s) to the user;

FIG. 24 shows one embodiment of a database server having a combination index component that can provide the applications-based refinement functionality and/or a more efficient way of accessing data given a search query; and

FIG. 25 shows one embodiment of a database entity relationship arrangement that can be used to generate the combination index.

These and other aspects, advantages, and novel features of the present teachings will become apparent upon reading the following detailed description and upon reference to the accompanying drawings. In the drawings, similar elements have similar reference numerals.

### DETAILED DESCRIPTION OF SOME EMBODIMENTS

The present disclosure generally relates to systems and methods for performing electronic searches. Many online purchases are made based on searches of various catalog databases. Such searches can yield quick and meaningful results if an item being searched for belongs to a relatively small and/or well defined market. However, if there are large numbers of different items, performing and obtaining meaningful and efficient searches become more difficult. It is quite likely that many of such items will be referred to in different terms, and such ambiguities can make meaningful searching more problematic. Moreover, there may be multiple versions of functionally similar items to accommodate different models of products.

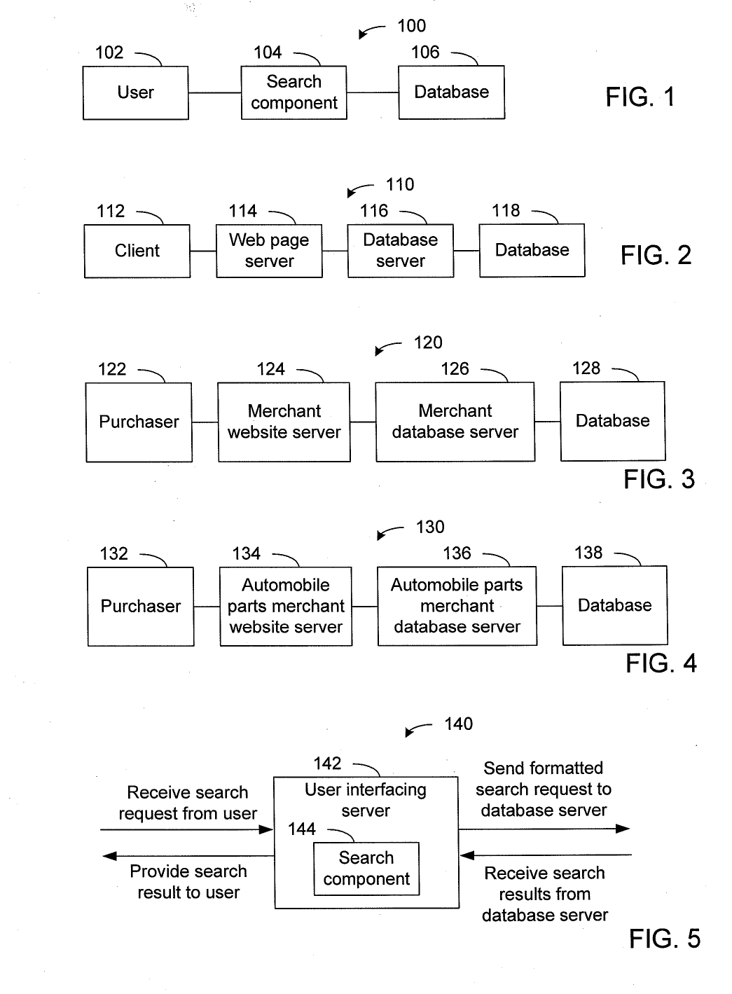

In some embodiments, various features of the present disclosure can make searches involving large number of items more meaningful and efficient. FIG. 1 shows that in one embodiment, a search configuration 100 can involve a search component 104 that provides an interface between a user 102 and a database 106. The search component 104 can be configured to allow preparation of search requests from the user 102 into a selected search query format prior to submission to the database 106 for actual searching. Such search queries can make the actual searches at the database 106 significantly more focused and meaningful. Thus, such “investment” of computing resources by a plurality of search components 104 can pay off when the database 106 is subjected to a heavy load of search requests from large number of users.

FIG. 2 shows that in one embodiment, a search configuration 110 can include a web page server 114 configured to provide interface with one or more users or clients 112 and a database 118. In one embodiment, the database 118 can be served by a database server 116, so that the web page server 114 interacts with the database 118 via the database server 116. In one embodiment, various functionalities of the search component 104 of FIG. 1 can be implemented in the web page server 114.

FIG. 3 shows that in one embodiment 120, the web page server 114 of FIG. 2 can be part of merchant website server 124 configured to facilitate online business with a plurality of purchasers 122. Because many purchasers 122 do not know exactly what the item is called or which category it belongs to, most merchant web pages have search capabilities for searching their own and/or others' online catalogs. Such online catalogs are depicted collectively as a database 128 in FIG. 3.

FIG. 4 shows that in one example situation 130, the merchant of FIG. 3 can be a merchant that deals in automobile parts. As shown, various features of the search component can be implemented in a server 134 that provides websites for the automobile parts merchant. As described herein, various functionalities of the search component are described in the context of automobile parts, so that search queries prepared by the server 134 in response to search requests from purchasers 132 are submitted to an automobile parts catalog database 138 via a database server 136. It will be understood, however, that various features of the present disclosure can also be applied to other situations where efficient and meaningful searches are desired. For example, cataloged parts for other products (airplanes, motorcycles, boats, appliances, consumer goods, etc.) can be searched in a manner similar to the various features of the present disclosure.

FIG. 5 shows one embodiment 140 of a search component 144 functionality that can be implemented in any of the situations described above in reference to FIGS. 1-4. In one embodiment, at least some portion of the functionalities of the search component 144 can reside on a server 142 configured to interface with users. Thus, the search component 144 can receive a search request from a user. Based on the search request, the search component 144 can form and send a formatted search query to a database server. The database server can then effectuate a search in a database (not shown) based on the formatted search query, and return search results to the search component 144. The search results can then be provided to the user.

In many user-generated search requests, there may be misspellings and/or errors. Users may not even know what the part is called, or rely on abbreviations that may not be uniformly used. These problems can be particularly apparent for automotive parts that affect a large segment of the general population.

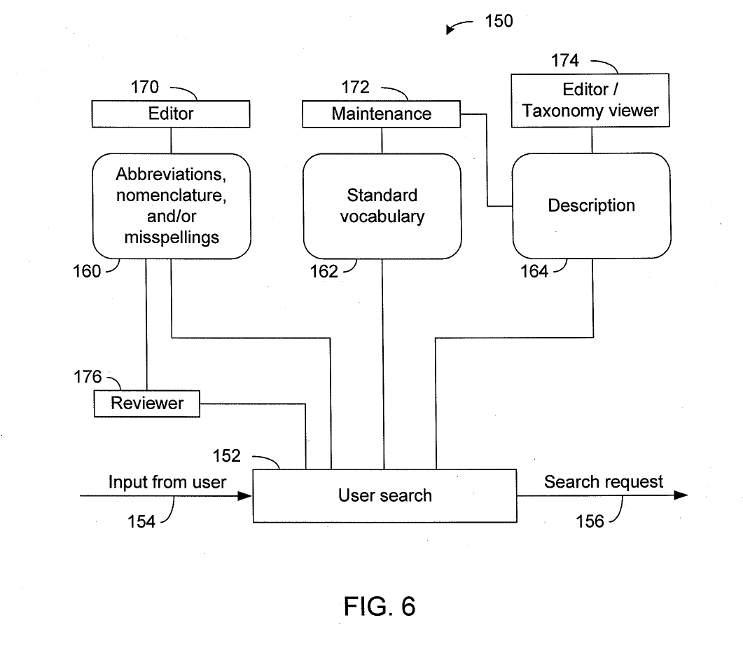

FIG. 6 shows that in one embodiment 150, a user search 152 can involve receiving an input 154 from a user (not shown). For example, a search request entered by the user can be the input 154. The user search 152 is shown to send a search request 156 to a database (not shown).

As previously described, user inputs can have various inaccuracies due to misspellings, abbreviations, and the like. In one embodiment, the user search 152, in generating the search request 156 from the user input 154, can involve an abbreviation dictionary 160, a standard vocabulary 162, and/or a description dictionary 164 in manners described herein. In one embodiment, the abbreviation dictionary 160 can include translations for common abbreviations, common misspellings, and/or common alternate nomenclatures. Examples involving the abbreviation dictionary 160 are described below in greater detail.

FIG. 6 further shows that in one embodiment, the abbreviation dictionary 160 can be edited (by an editor component 170) to add, remove, or modify the entries of abbreviation definitions therein. Such editing can be performed to update the dictionary, and such updates are described below in greater detail.

FIG. 6 further shows that in one embodiment, a reviewer 176 can be configured to present terms (obtained from the user input 154) that do not have any matching entries in the abbreviation dictionary 160 to the user. In one embodiment, such non-matching terms may not be usable for further processing; so a clarification from the user may be beneficial. For example, suppose that a term “zxc” is encountered in the user input 154, and there is no definition for “zxc” in the abbreviation dictionary 160. In one embodiment, the reviewer 176 can present the entire user input 154 with the term “zxc” highlighted, and request that the user correct that term. Once corrected, the user input can be processed further.

In one embodiment, the standard vocabulary 162 can include a list of standardized words that are involved in describing automobile parts. Examples involving the standard vocabulary 162 are described below in greater detail.

FIG. 6 further shows that in one embodiment, the standard vocabulary 162 can be maintained (by a maintenance component 172) to update the standardized words therein. In one embodiment, the maintenance of the standard vocabulary 162 can be based on the description dictionary 164. An example of such maintaining is described below in greater detail.

In one embodiment, the description dictionary 164 can include a list of descriptions of automobile parts. Examples involving the description dictionary 164 are described below in greater detail.

FIG. 6 further shows that in one embodiment, the description dictionary 164 can be edited (by an editor component 174) to edit the list of descriptions therein. In one embodiment, the editor component 174 can include a functionality where the list of descriptions are presented to the editor in a taxonomically arranged manner. An example of such editing and taxonomic viewing is described below in greater detail.

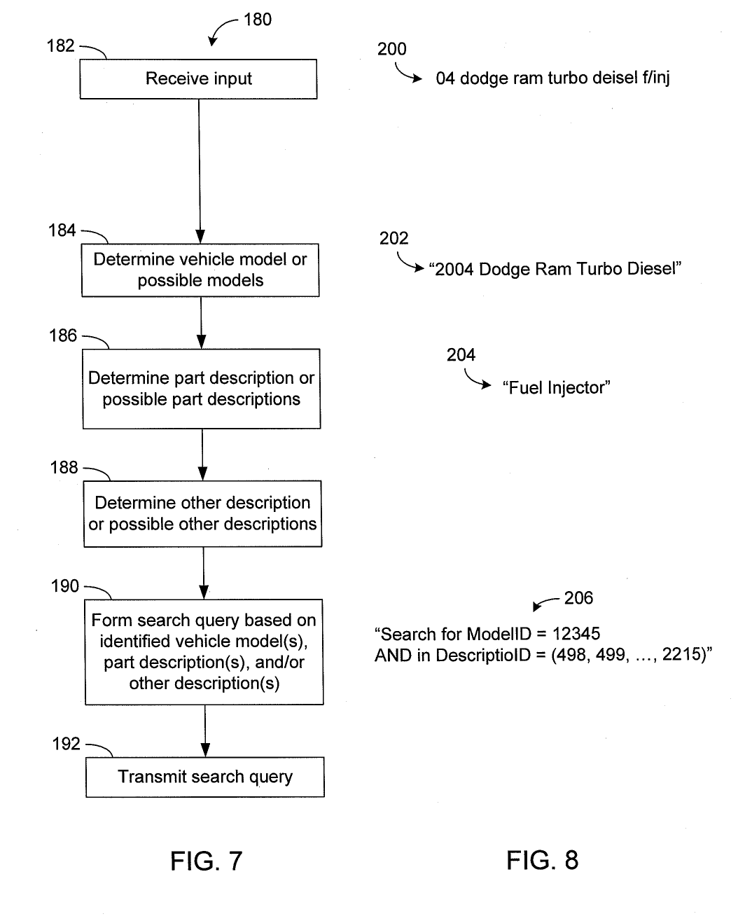

FIG. 7 shows one embodiment of a process 180 that can be performed by the search component to effectuate the user search 152 of FIG. 6. FIG. 8 shows specific examples corresponding to various steps of the process 180.

In a process block 182, a user input is received. A string 200 of “04 dodge ram turbo deisel f/inj” is an example of the user input.

In one embodiment, the process 180 can determine which of the terms are for identifying the model or possible models of automobile, and which are for identifying the part or possible parts being sought. To achieve such functionality, the process 180 can first determine the vehicle model or possible models in a process block 184.

In one embodiment, a rule can be implemented where terms in the user input are processed from left to right. Moreover, a rule can be formed based on observations that an average user will input the model information first (from the left). These rules are simply example, and other rules are possible.

In one embodiment, the terms of the user input are compared to an abbreviation dictionary having entries relating to automobile models. As previously described, untranslated terms may be abbreviations, alternate nomenclatures, and/or nomenclatures that occur commonly. Thus, in the example of FIG. 8, “04” can be an abbreviation for “2004” in the abbreviation dictionary. The example terms “dodge” and “ram” are both part of standard vocabulary relating to automobile models, and thus can be translated to “Dodge” and “Ram.”

The example term “turbo” can be either for describing an automobile model or for describing an automobile part. In one embodiment, the process 180 can resolve such ambiguity by prioritizing the term translations and/or performing look-aheads to look for confirmatory words. In this example, automobile-model terms are given priority over automobile-part terms. Thus, the term “turbo” is assigned to mean a “Turbo” model of the “Dodge Ram.” In one embodiment, once a term is “consumed” (for automobile-model in this example), it is not used for any other purpose.

In some situations, look-aheads of terms can group terms that should be associated together. For example, when considering the term “turbo,” the process 180 may look ahead to see there are any terms that are associated with the term “turbo.” In this example, the misspelled term “deisel” is first found to be a common misspelling in the automobile-model abbreviation table, and thus is translated to “diesel.” A look-ahead from “turbo” shows that “turbo diesel” is a defined term in the automobile-model abbreviation dictionary to mean a model “Turbo Diesel.” Thus, the terms “turbo” and “deisel” are consumed to form the model modifier “Turbo Diesel.”

In the example, the term “f/inj” is found to be neither an abbreviation nor a look-ahead companion with any other term in the automobile-model abbreviation dictionary. Thus, the term “f/inj” is not consumed for automobile-model identification, and is left for other identification(s).

Based on the foregoing example, the process block 184 determines that the example user input “04 dodge ram turbo deisel f/inj” means a vehicle model “2004 Dodge Ram Turbo Diesel” (202 in FIG. 8).

In a process block 186, the process 180 can determine the automobile part or possible parts based on the remaining term(s). In the example shown in FIG. 8, the remaining term is “f/inj,” and that term is found to be defined in an automobile-part abbreviation dictionary as meaning “Fuel Injector” (204 in FIG. 8). Thus, all of the terms in the example user input “04 dodge ram turbo deisel f/inj” have been translated to mean that the user wishes to search for “Fuel Injector” for vehicle model “2004 Dodge Ram Turbo Diesel.”

In a process block 188, the process 180 can determine other description(s) based on the remaining term(s) in a similar manner. The other description can include, for example, part numbers that may be entered directly by the user. In the example of FIG. 8, such part numbers are not involved, and thus are not shown.

In some situations, part numbers may be typed in by the user with spaces, dashes, and or other punctuations. In one embodiment, spaces can define separation into separate terms, and punctuations can be removed prior to making comparisons with part number definitions in one or more dictionaries. In one embodiment, the part number identification can be performed after other identification(s) to reduce the likelihood of misrecognizing pieces of part numbers as meaning something else. In one embodiment, part number matching can also accommodate wildcard characters such as a “*”.

In some input situations, there may be one or more terms that are not defined in any abbreviation dictionary or standard vocabulary. In such situations, a reviewer (such as the reviewer 176 in FIG. 6) can be invoked to request correction or clarification for the undefined term(s) from the user. In one embodiment, the process 180 can be configured so that the undefined term(s) can be ignored if it determines that sufficient information has been obtained from the matchings.

In a process block 190, a search query can be formed based on the identified vehicle model(s), part description(s), and/or other description(s) (such as part number(s)). In the example of FIG. 8, an example search query 206 can include search commands such as “Search for ModelID=12345 AND in DescriptionID=(498, 499, . . . , 2215).” Such well-defined and focused search instruction can be obtained from a relatively sloppy user input because of the various dictionaries that provide translations and standard words.

In a process block 192, the search query can be transmitted to the database where an electronic catalog search can be performed.

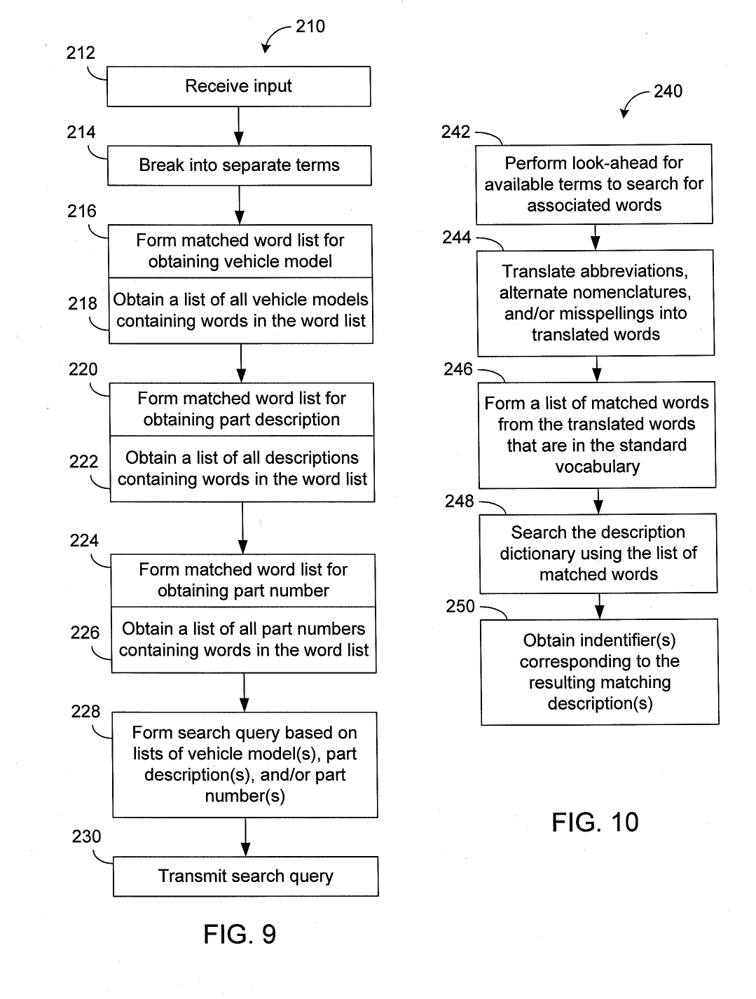

FIG. 9 shows one embodiment of a process 210 that can be a more specific example of the process 180 of FIG. 8. In a process block 212, an input is received from a user. In a process block 214, the input can be separated into individual terms. In one embodiment, the terms are separated wherever spaces are present in the input string of characters.

In a process block 216, a matched word list relating to vehicle models can be formed. In a process block 218, a list of all vehicle models that contain the matched words is obtained. An example of a process that can obtain the matched word list and the vehicle model list is described below in greater detail.

In a process block 220, a matched word list relating to part descriptions can be formed. In a process block 222, a list of all part descriptions that contain the matched words is obtained. An example of a process that can obtain the matched word list and the part description list is described below in greater detail.

In a process block 224, a matched word list relating to part numbers can be formed. In a process block 226, a list of all part numbers that contain the matched words is obtained. An example of a process that can obtain the matched word list and the part number list is described below in greater detail.

In a process block 228, a search query is formed based on lists of vehicle model(s), part description(s), and/or part number(s). As described above in reference to FIG. 8, other description(s) relating to parts or vehicles can also be matched and included in the search query.

In a process block 230, the formed search query is transmitted to the database for searching.

FIG. 10 shows one embodiment of a process 240 that can provide the matching of input terms to vehicle models, part descriptions, and part numbers. In a process block 242, a look-ahead is performed on available terms to search for associated words. In a process block 244, abbreviations, alternate nomenclatures, and/or misspellings are translated into words based on an abbreviation dictionary. In a process block 246, a list of matched words is formed from the translated words that are also in a standard vocabulary. In a process block 248, a description dictionary is search for the matched words. In one embodiment, all of the matched words need to be present for a given description to be considered a match with the matched words. In a process block 250, identifiers corresponding to the matched descriptions are obtained, and such identifiers can be used to form the search query.

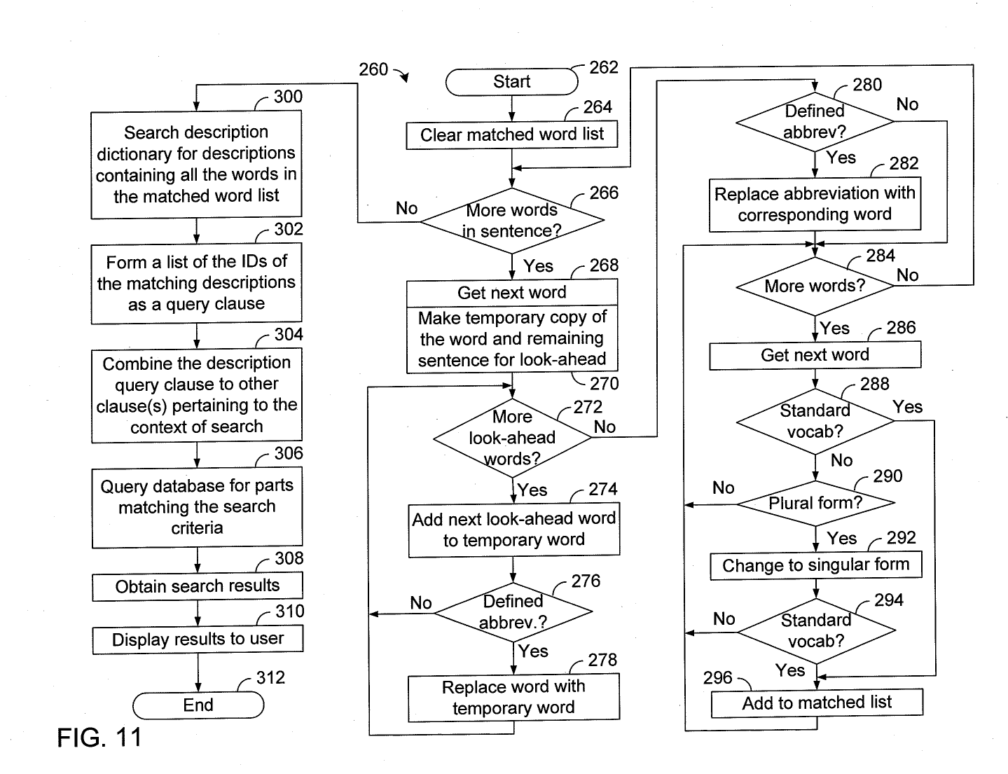

FIG. 11 shows one embodiment of a process 260 that can be a more specific example of the processes 210 and 240 of FIGS. 9 and 10, as applied to part-descriptions. The process 260 begins at a start state 262, and in a process block 264, a matched list is cleared. Then the process 260 begins analyzing each of the separated terms. In one embodiment, the terms are analyzed from left to right. For the purpose of describing process 260, it will be assumed that terms relating to vehicle models have already been consumed, and the remaining terms relate to part-descriptions.

Thus, as shown in FIG. 11, the process 260 loops through the remaining terms to generate matched words. In a decision block 266, the process 260 determines whether there are more words to be matched. If the answer is “Yes,” the process 260 in a process block 268 analyzes the next term. If the answer is “No,” the matched word list is considered to be complete, and the process 260 performs matching operations with part-descriptions in a manner described below.

As shown in FIG. 11, the process 260 in the process block 268 obtains the next term for analysis. In a process block 270, the process 260 makes a temporary copy of the term and the remaining sentence (a collection of remaining terms for the purpose of FIG. 11). The process 260 then performs a look-ahead based on the current term. In a decision block 272, the process 260 determines whether there are more look-ahead terms to consider. If the answer is “No,” the look-ahead for the current term is finished, and the process 260 proceeds to abbreviation translation of the current term or the associated words resulting from the look-ahead. If the answer is “Yes,” the process 260 attempt to form association of the current term with the next term in a process block 274.

In a decision block 276, the process 260 determines whether the combination of the terms from the process block 274 is defined in an abbreviation dictionary. If the answer is “No,” then the terms are considered not to be associated, and the current word is analyzed separately. If the answer is “Yes,” then the terms are considered to be associated, and the current word is replaced with the combination of the terms in a process block 278. The added term is now considered to have been consumed. The process 260 loops back to the decision block 272 to see if there are more terms to perform look-ahead on.

As described above, a “No” answer in the decision block 272 indicates that the look-ahead for the current term is finished. The process 260 in a decision block 280 determines whether each of the associated words resulting from the look-ahead has a definition in the abbreviation dictionary. If the answer in the decision block 280 is “No,” no action is taken on the term. If the answer is “Yes,” the term is replaced with the corresponding word as defined, in a process block 282.

The process 260 in a decision block 284 then determines whether each of the abbreviation translated words has been checked against a standard vocabulary (by asking whether there are more words to process). If the answer is “No,” then the process 260 returns to the decision block 266 to see if there are more terms to analyze as described above. If the answer is “Yes,” then the process 260 in a process block 286 obtains the next of the associated words.

The process 260 in a decision block 288 determines whether that word is in the standard vocabulary. If the answer is “Yes,” that word is added to the matched list in a process block 296. If the answer is “No,” the process 260 determines whether the word is in a plural form. If the answer is “Yes,” then a singular form of the word is obtained in a process block 292. If the answer is “No,” the word is considered not to be in the standard vocabulary, and it not added to the matched list. The process 260 returns to the decision block 284 to see if there are more words for processing.

The process 260 in a decision block 294 once again determines whether the singular form of the word (obtained in the process block 292) is in the standard vocabulary. If the answer is “No,” the singular form of the word is considered not to be in the standard vocabulary, and it not added to the matched list. The process 260 returns to the decision block 284 to see if there are more words for processing. If the answer in the decision block 294 is “Yes,” the singular form of the word is considered to be in the standard vocabulary, and the word is added to the matched list in the process block 296. The process 260 then loops back to the decision block 284 to see if there are more words for processing.

As described above, a “No” answer in the decision block 266 meant that the matched word list is considered to be complete. In one embodiment, the process 260 in a process block 300 searches a description dictionary for descriptions containing all of the words in the matched word list. In a process block 302, the process forms a list of identifiers corresponding to the descriptions obtained in the process block 300. In one embodiment, such identifiers can become part of a search query clause.

In a process block 304, the process 260 combines the description query clause with other clause(s) pertaining to the context of the search. For example, a vehicle model query clause obtained in a similar manner can be combined with the description search clause in the process block 304.

In a process block 306, the process 260 can send the combined search query to a database. In a process block 308, the process 260 is shown to receive the results of the search query from the database. In a process block 310, the process 260 can send the search results to the user. The process 260 is shown to end at the end state 312.

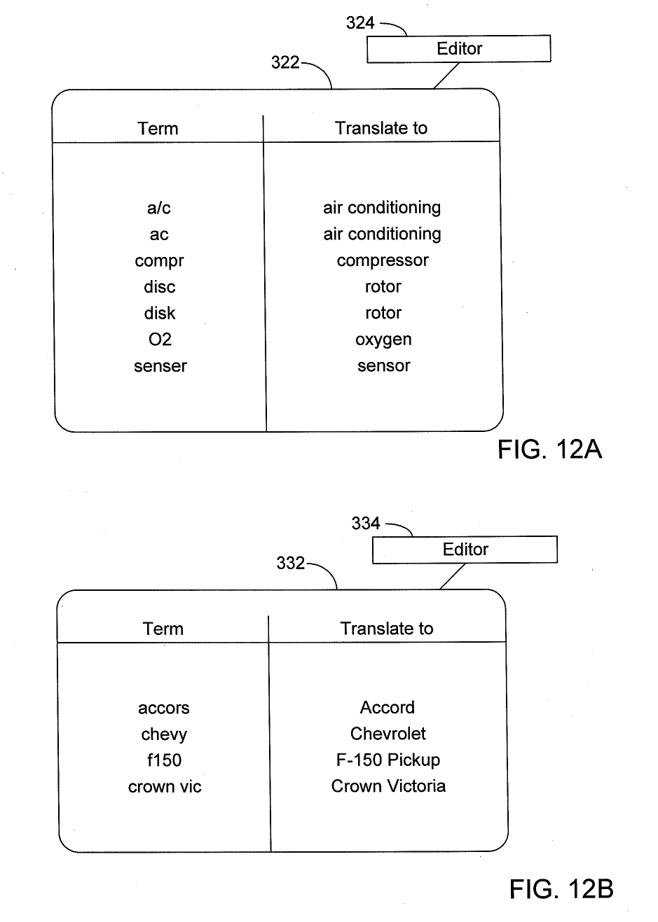

FIG. 12A shows by way of example one embodiment of an abbreviation dictionary 322. As previously described, the abbreviation dictionary 322 can include translations for abbreviated words such as “a/c” and “ac.” Such common abbreviations are shown to be defined to mean “air conditioning.” Similarly, an abbreviation “compr” is shown to be defined to mean “compressor.”

In one embodiment, the abbreviation dictionary 322 can also include definitions for alternate nomenclatures. For example, terms “disc” and “disk” are not necessarily abbreviations, but are shown to be defined to mean “rotor.” Similarly, a term “O2” is a common way of expressing oxygen; and thus is defined to mean “oxygen.”

In one embodiment, the abbreviation dictionary 322 can also include definitions for misspellings. For example, a misspelled term “senser” is defined to mean “sensor.” In one embodiment, misspellings that could occur easily due to common typing errors can be included in the abbreviation dictionary. For example, a common mistake can involve two letters being switched during typing. Thus, a term “filetr” has letters “e” and “t” switched, and can be defined to mean “filter.” In another example, a common mistake can involve mistyping one vowel key that is next to another vowel key. Thus, a term “folter” (where the “o” key is next to the “i” key) can be defined to mean “filter.”

In one embodiment, the abbreviation dictionary 322 can be edited by an editor 324 to add, remove, and/or modify entries. Thus, for example, if there is a commonly occurring error being input by users, such error can be defined to mean its intended term. In one embodiment, an interaction with users (for example, via the reviewer 176 in FIG. 6) can facilitate determination of such commonly occurring errors.

In one embodiment, the abbreviation dictionary 322 can be in a lookup table, be hardcoded, any combination thereof, or in any other form. In one embodiment, abbreviation dictionary 322 can be stored as a substantially single file, or in a plurality of files. In one embodiment, the abbreviation dictionary 322 can reside in a local memory of a user-interfacing server so as to allow processing of user inputs prior to submitting search queries to catalog databases. Other configurations are possible.

In the example abbreviation dictionary 322 of FIG. 12A, the example entries relate to part-descriptions. In one embodiment, a similar abbreviation dictionary can be formed, where the entries relate to vehicle model descriptions.

FIG. 12B shows by way of example one embodiment of an abbreviation dictionary 332, where the entries relate to words associated with vehicle model identification. In one embodiment, the abbreviation dictionary 332 can provide translations for abbreviations (for example, “chevy” to mean “Chevrolet,” and “crown vic” to mean “Crown Victoria”), alternate nomenclatures (for example, “f150” to mean “F-150 Pickup”), and misspellings (for example, “accors” to mean “Accord”).

In one embodiment, the abbreviation dictionary 332 can be edited by an editor 334 to add, remove, and/or modify entries. Thus, for example, if there is a commonly occurring error being input by users, such error can be defined to mean its intended term. In one embodiment, an interaction with users (for example, via the reviewer 176 in FIG. 6) can facilitate determination of such commonly occurring errors.

In one embodiment, the abbreviation dictionary 332 can be in a lookup table, be hardcoded, any combination thereof, or in any other form. In one embodiment, abbreviation dictionary 332 can be stored as a substantially single file, or in a plurality of files. In one embodiment, the abbreviation dictionary 332 can reside in a local memory of a user-interfacing server so as to allow processing of user inputs prior to submitting search queries to catalog databases. Other configurations are possible.

In one embodiment, the parts abbreviation dictionary 322 and the vehicle-models abbreviation dictionary 332 can be stored as separate files. In one embodiment, the two example dictionaries can be stored in a same file, yet be delineated so that one dictionary is not searched while matches are being made using the other dictionary. Other storage configurations are possible.

In one embodiment, other abbreviation dictionaries can be implemented. For example, an abbreviation dictionary relating to part-numbers can be formed and implemented to allow identification of part numbers (for example, in FIGS. 7 and 9).

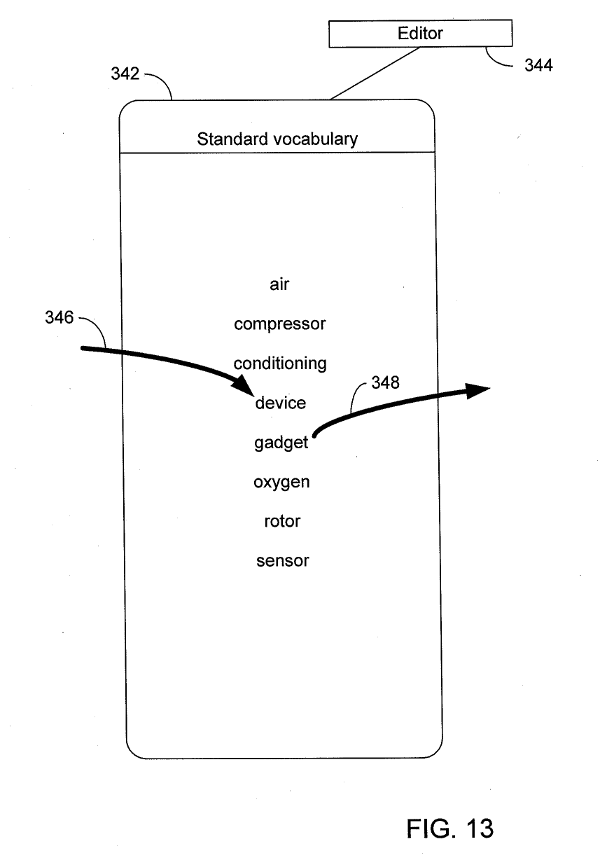

FIG. 13 shows by way of example one embodiment of a standard vocabulary 342 having words relating to automobile parts. Similar vocabularies can be provided for words relating to, for example, vehicle-models and part-numbers.

In one embodiment, the standard vocabulary 342 includes standardized words as entries. Thus, for example, standardized words “air” and “conditioning” are shown to be found in the vocabulary 342 to account for the example translated phrase “air conditioning” (in the example abbreviation dictionary 322).

In one embodiment, each word in the standard vocabulary 342 is unique, in that it is not duplicated in the same vocabulary. Such uniqueness can reduce the likelihood of confusion when forming the matched list of words (for example, in FIGS. 9 and 11).

In one embodiment, the standard vocabulary 342 can be maintained and/or edited by an editor 344. Maintenance of the standard vocabulary 342 in described below in greater detail. Whether by maintenance or by editing, words can be added (depicted as an arrow 346), removed (depicted as an arrow 348), or edited. Thus, for example, if the example term “gadget” is no longer used, it can be removed to reduce unnecessary increase in search time. Similarly, if the example term “device” is now being used, it can be added to the vocabulary.

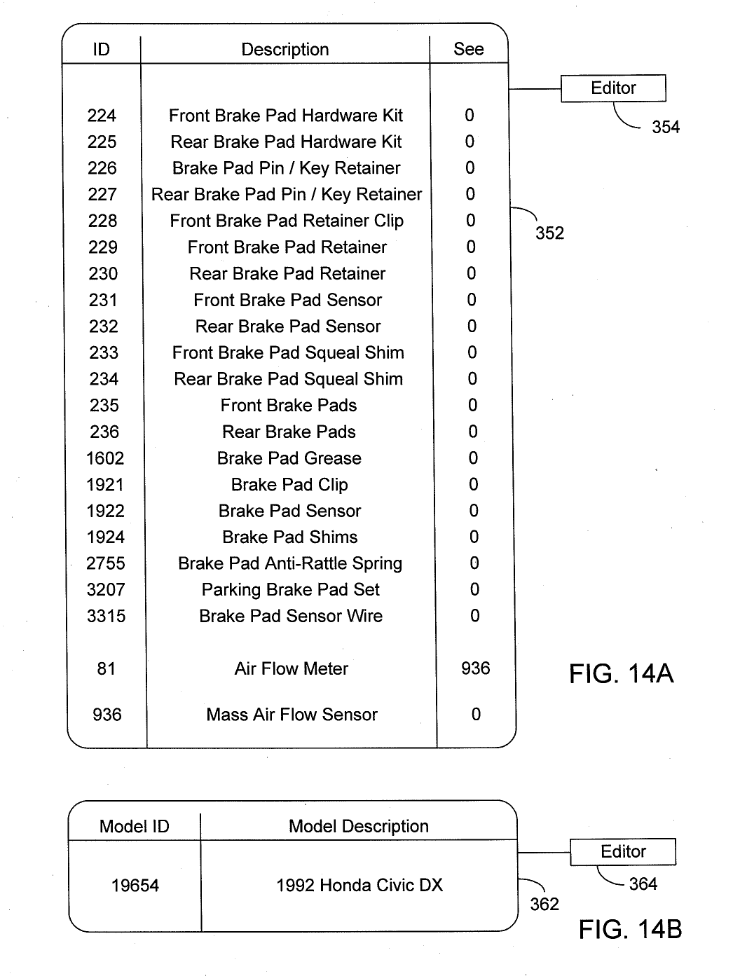

FIG. 14A shows by way of example one embodiment of a description dictionary 352 having a list of descriptions relating to automobile parts. Example entries having words “brake” and “pad” are shown (ID numbers “224” to “3315”). These example entries are shown together for the purpose of description.

In one embodiment, each description entry is assigned an identifier (shown in the ID column). For example, the description “Front Brake Pad Hardware Kit” is assigned an ID of “224.” In one embodiment, each description entry is also assigned an alternate description indicator. In the example shown, an alternate description indicator of “0” indicates that the description is the primary description. If the description is not a primary description, then it's alternate description indicator can indicate the ID of the primary description. Thus, for example, the description “Air Flow Meter” (ID=81) is considered not to be a primary description. Thus, it's alternate description indicator is shown to be “936” that points to the ID=936 primary description “Mass Air Flow Sensor.”

In one embodiment, the description dictionary 352 can be maintained and/or edited by an editor 354 to add, remove, and/or modify entries. An example for maintenance of the description dictionary is described below in greater detail.

In one embodiment, the description dictionary 352 can be in a lookup table, be hardcoded, any combination thereof, or in any other form. In one embodiment, description dictionary 352 can be stored as a substantially single file, or in a plurality of files. In one embodiment, the description dictionary 352 can reside in a local memory of a user-interfacing server so as to allow processing of user inputs prior to submitting search queries to catalog databases. Other configurations are possible.

FIG. 14B shows by way of example one embodiment of a description dictionary 362 having a list of descriptions relating to vehicle models. An example entry for “1992 Honda Civic DX” is shown to have a model identifier of ModelID=19654. In one embodiment, description entries in the description dictionary 362 can have more or less specific model description. For example, an entry “1992 Honda Civic” may be assigned a different ModelID, and thus would result in a wider search than a search involving ModelID=19654.

In one embodiment, the description dictionary 362 can be maintained and/or edited by an editor 364 to add, remove, and/or modify entries. For example, as new vehicles are introduced into the market, descriptions of such vehicles can be added to the description dictionary 362.

In one embodiment, the parts description dictionary 352 and the vehicle-models description dictionary 362 can be stored as separate files. In one embodiment, the two example dictionaries can be stored in a same file, yet be delineated so that one dictionary is not searched while matches are being made using the other dictionary. Other storage configurations are possible.

In one embodiment, other description dictionaries can be implemented. For example, description dictionary relating to part-numbers can be formed and implemented to allow identification of part numbers (for example, in FIGS. 7 and 9).

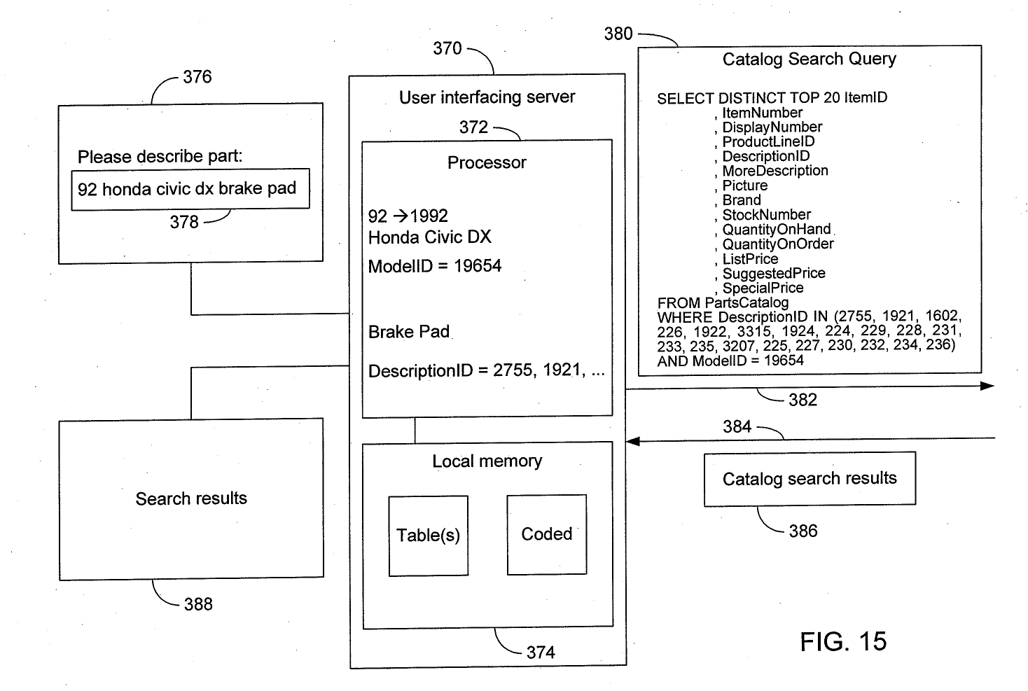

FIG. 15 shows by way of example a search processing that can be performed utilizing the various features described above. In one embodiment, processing of a user input can be performed on a user interfacing server 370. A processor 372 can be configured to perform the various processes described above (for example, FIGS. 7 and 9-11). The server 370 can also be configured to have access to a local memory 374, on which can be various dictionaries and vocabularies. In one embodiment, such dictionaries and vocabularies can be in a table format, coded format, some combination thereof, or any other format.

In the example shown, the server is shown to be in communication with a user terminal 376, on which is displayed a search request prompt 378. For the purpose of description, a search request of “92 honda civic brake pad” is shown to be entered by the user. The processor 372 is depicted as determining that “92” refers to “1992,” and that “honda civic dx” refers to a model “Honda Civic DX.” Based on such determination, a model identifier of ModelID=19654 is assigned.

The processor 372 is also depicted as determining that the remaining words “brake” and “pad” match with standard vocabulary words “Brake” and “Pad.” Thus, these two example matched words are searched in the description dictionary, and the resulting DescriptionIDs are obtained (“2755,” “1921,” . . . )

Based on such determination of vehicle model and possible parts, an example search query 380 can include information for performing a well-defined and focused search. The example “SELECT” field instructs what types of information are being sought. The “FROM” field indicates which catalog to search in. The “WHERE” field indicates portions of the catalog where search should be performed. As shown, the example description identifiers corresponding to descriptions having “brake” and “pad” (see the example listing in FIG. 14A) are included in this field. The ModelID further narrows down the search by indicating the model of the vehicle involved.

As shown in FIG. 15, the example search query 380 can be sent (depicted as an arrow 382) to a database (not shown). The search result from the database search is depicted as 386, and is shown to be received from the database (arrow 384). The search result 386 can then be presented to the user (block 388).

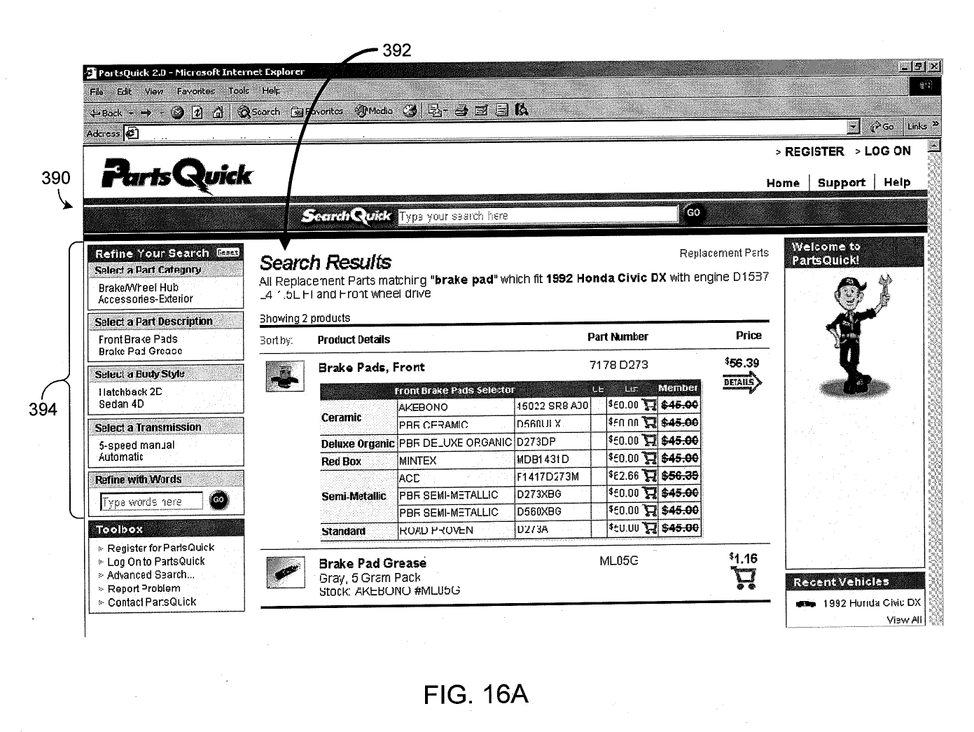

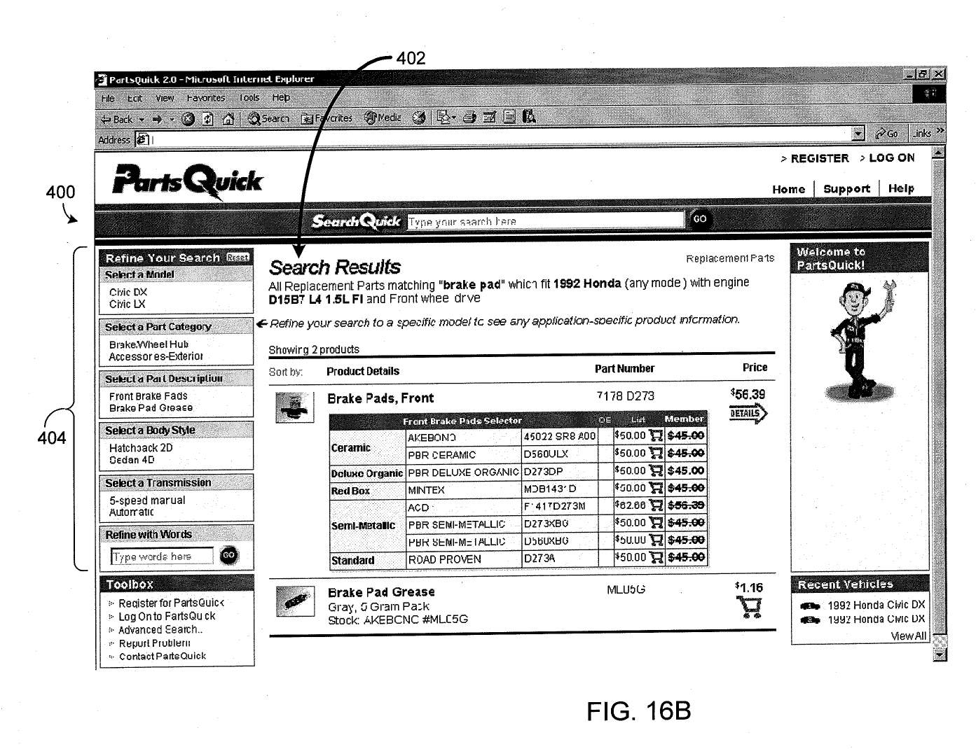

FIG. 16A is an example screen shot 390 of the search result (388 in FIG. 15) that can be presented to the user. In one embodiment, search description 392 can indicate what the search was based on. In this example, the description 392 indicates that the results displayed correspond to “brake pads” that fit “1992 Honda Civic DX.” The description 392 further indicates the engine information and that the model is a front-wheel drive. Such additional information can be added if they are unique to the determined model.

As further shown in FIG. 16A, there may be room for further refinement of the search results, and this example feature is indicated as 394. For example, the “1992 Honda Civic DX” may have manual or automatic transmissions; thus such alternatives are shown for further refinement. Similarly, the body style may be a 2-door hatchback or a 4-door sedan; and such alternatives are also shown.

In one embodiment, the search component of the present disclosure can be configured so that if no alternative is given to the user, the displayed part(s) will fit all variations of the particular attribute. For example, the engine type is not listed as an alternative; thus, the listed brake pad parts are assumed to fit all types of engine(s) for this particular model, even if such information is not presented in the description 392.

In one embodiment, search results presented to the user can be configured to allow modifications of the search. For example, the example refinement provision 394 can narrow the search. The search can also be broadened by removing one or more of the search terms. In the particular example shown in FIG. 16A, a search term can be removed by clicking on the term displayed on the search description. Thus, if one wants to broaden the search by where the parts are not limited to “Civic DX,” the “Civic DX” can be clicked on. FIG. 16B shows an example screen shot 400 of the resulting broadened search. Note that the search description 402 reflects the modified search, and the search refinement provision 404 now contains alternatives for “Civic” models.

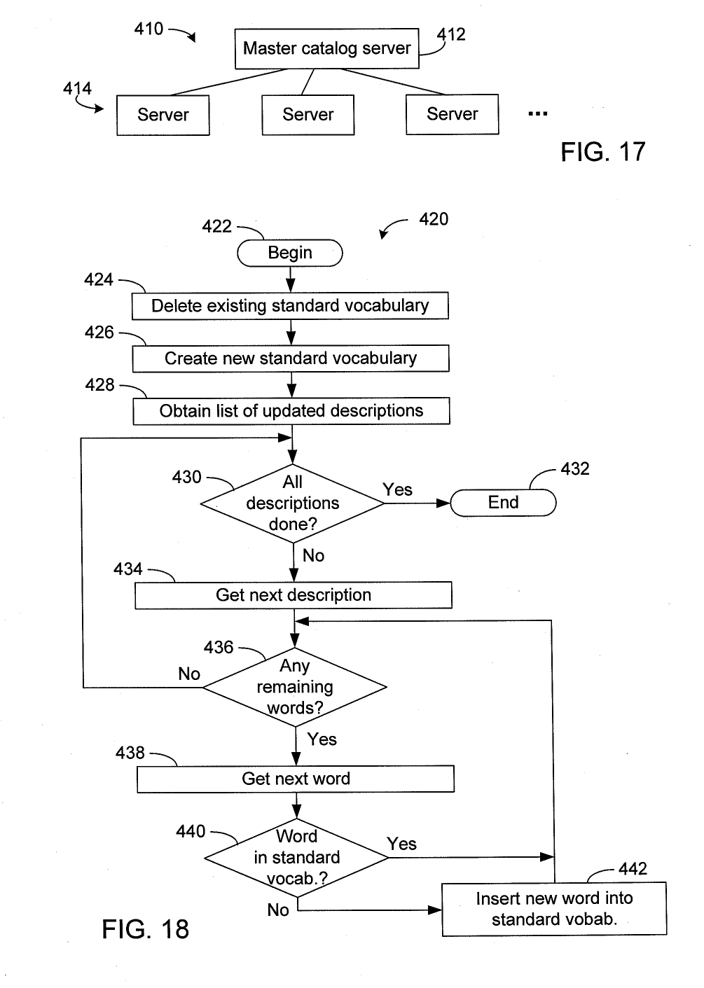

As described herein, processing of search requests from users at servers prior to searching at the databases can provide for more meaningful and efficient searches. If there are a plurality of such servers, it is preferable that they operate with the same set of dictionaries and vocabularies. Thus, in one embodiment 410, as shown in FIG. 17, a plurality of servers 414 can be maintained by a master catalog server 412 to provide such coordination. In one embodiment, the master server 412 can be configured to allow editing of the abbreviation dictionaries, standard vocabularies, and/or the description dictionaries.

FIG. 18 shows an example process 420 that can be implemented to maintain the standard vocabulary based on an updated description dictionary. In one embodiment, the description dictionary can be updated by inputting descriptions relating to new parts. Alternatively, descriptions can be provided by part manufacturers or other entities. If such descriptions can be relied on as conforming to some standard for description dictionary, they can be added to the description dictionary. Such manufacturer provided descriptions can be edited before being added to the description dictionary.

Whatever the process may be, it may be desirable to have a reference from which vocabulary words are formed. Thus, in one embodiment, the updated description dictionary can be used as a reference of collection of standard words, and the standard vocabulary can be updated accordingly.

As shown in FIG. 18, the process 420 starts at a begin state 422, and in a process block 424, the existing standard vocabulary is deleted. In a process block 426, a new standard vocabulary is created. In a process block 428, a list of updated descriptions is obtained.

The process 420 is then shown to loop through the list of descriptions. Thus, if all the descriptions are processed (decision block 430), the process ends at the end state 432. If not, the process 420 in a process block 434 processes the next description.

For that description, the process 420 loops through the words in the description. Thus, if there is no more remaining word (decision block 436), the process loops back to the decision block 430 to see if all the descriptions have been processed. If there is a remaining word, that word is obtained in a process block 438, and a determination is made to see (decision block 440) if that word is already in the new standard vocabulary. If “Yes,” that word is not inserted into the new standard vocabulary. If “No,” that word is inserted into the new standard vocabulary in a process block 442. The process 420 then loops back to the decision block 436 to see if there are anymore remaining words to process.

As one can see, such building of new standard vocabulary ensures that the vocabulary includes all of the words found in the latest description dictionary. Moreover, each of the words in the new vocabulary will be unique, in that each word occurs once.

In one embodiment, the foregoing updating of the standard vocabulary can occur whenever the description dictionary is updated, or on a periodic basis. In one embodiment, the updating can be performed on a daily basis.

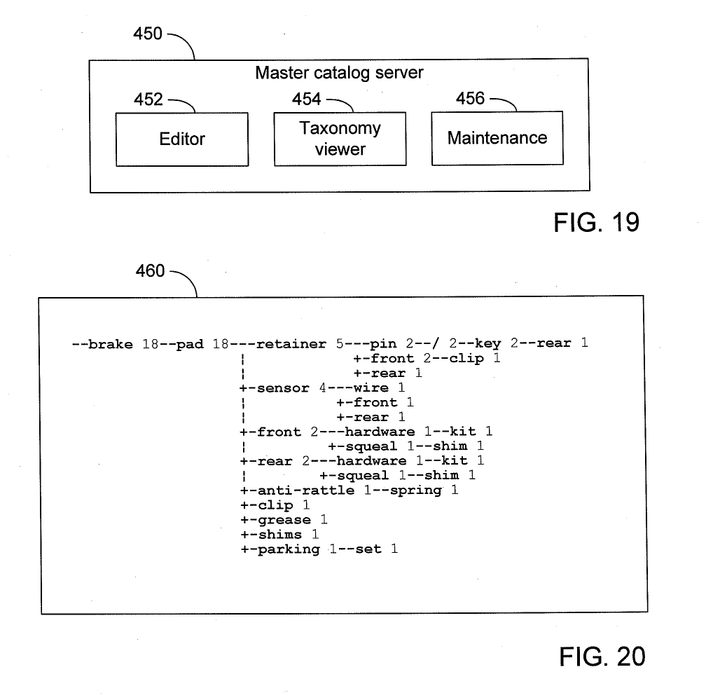

FIG. 19 show one embodiment of the master server 450 described above in reference to FIGS. 17 and 18. In one embodiment, the master server 450 can include an editor 452 configured to allow editing of the various dictionaries and/or vocabularies. In one embodiment, the master server 450 can also include a maintenance component 456 that can perform maintenance such as the updating described above in reference to FIG. 18. In one embodiment, the master server 450 can also include a viewer 454 that can provide a visual representation of word contents in the various dictionaries and vocabularies.

In one embodiment, the viewer 454 can be configured to taxonomically-arranged visual presentation of the words found in various dictionaries. FIG. 20 shows an example of such taxonomical view for example words “brake” and “pad.” In one embodiment, such taxonomically arranged view showing usage of words can provide useful information regarding frequency of word usage, context of word usage, and the like. Such information can lead to improvements in descriptions of various attributes.

As described herein, formation of search queries at user-interfacing servers can relieve the load imposed on the database. Moreover, meaningful search queries can be formed based on various dictionary definitions and/or vocabularies. Such meaningful queries can reduce unnecessary repeated interactions between the users and the servers, thereby reducing the load imposed on the servers as well.

In some searching situations, the database being searched can include more information than what is being asked by the user. For example, in FIGS. 15 and 16, an example search request for “92 honda civic dx brake pad” is discussed. As shown in FIG. 16A, the example result 390 presents to the user not only the available products (under “Product Details,” but also options for refining the search based on parameters that were not part of the original request. For example, the example refinement provision 394 allows the user to refine the search based of the type of transmission and body style. These example parameters are not part of the original search request. In one embodiment, these parameters are not part of the search query as well. However, the search result 390 is shown to provide additional search suggestions or options.

In some embodiments, such searching capability can be facilitated by searching for applications of parts instead of parts themselves. Thus, in one embodiment, the searches can be made for possible applications of parts to vehicle models. In the example shown in FIG. 16A, all possible applications are shown where “brake pad” and “1992 Honda Civic DX” are involved. Thus, the result shows that such an application involves an engine type “D15B7 L4 1.5 L FI” and a power train of “Front Wheel Drive.” For these examples, they are the only possibilities; and so, refinement options are not displayed.

The example result 390 (FIG. 16A) shows that the application can also involve different door body styles (“Hatchback 2D” or “Sedan 4D”), as well as different transmissions (“5-speed manual” or “Automatic”). Moreover, the application can also involve different categories of parts (for example, “Brake/Wheel Hub” or “Accessories-Exterior” category).

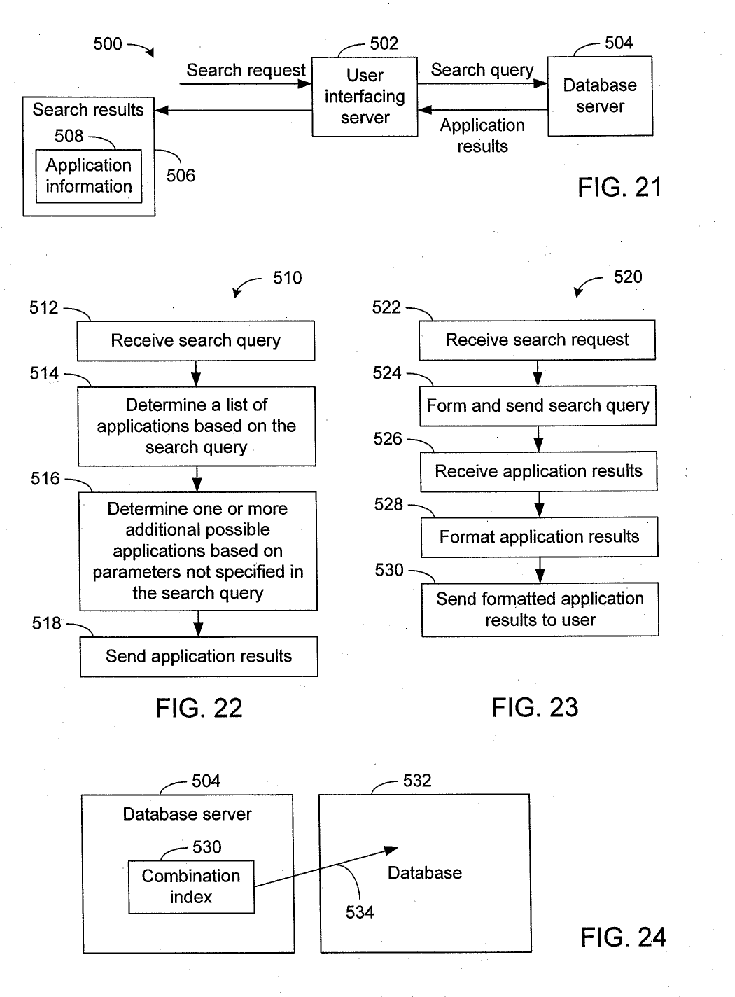

FIG. 21 shows a block diagram of one embodiment 500 where a search result 506 provided to the user includes an application information 508. In one embodiment, the application information 508 can include some information concerning how and/or where a part can be applied or used, even if such information was not requested in the original search request.

As described above in reference to FIG. 15, a search request from the user can be processed by a user-interfacing server 502, and a search query can be sent to a database server 504. In one embodiment, the database server can return application results to the user-interfacing server 502, and such results can be provided to the user as the application information 508.

FIG. 22 shows one embodiment of a process 510 that can be performed on the database server 504 of FIG. 21. In a process block 512, a search query is received. In a process block 514, the process 510 determines a list of applications based on the search query. In a process block 516, the process 510 determines one or more additional possible applications based on parameters not specified in the search query. In one embodiment, the process blocks 514 and 516 are not necessarily separate steps. For example, both determinations (search query-based and additional possible applications) can be conducted together, and presented separately. For example, in FIG. 16A, the “Search Results” showing the product details are the query-based applications, whereas the “Part Category,” “Body Style,” and “Transmission” are examples of additional possible applications.

As further shown in FIG. 22, the process 510 sends the application results to a server. In one embodiment, the results are sent to the server from which the search query was received.

FIG. 23 shows one embodiment of a process 520 that can be performed on the user-interfacing server. In a process block 522, a search request is received. In a process block 524, the process 520 forms and sends a search query to the database server. In a process block 526, the process 520 receives application results. In a process 528, the process 520 formats the application results. In a process 530, the process 520 sends the formatted application results to the user. FIG. 16A shows an example of the formatted application results.

FIG. 24 shows that in one embodiment a database server 502 can be configured to include a combination index 530 that can efficiently provide the possible applications in response to the search query. In one embodiment, the combination index 530 can also be configured to provide an address (depicted as an arrow 534) on a database 532 for obtaining information about particular applications.

In one embodiment, the combination index 530 can allow for substantially all the possible permutations of search query parameters in the database. However, such searching can be relatively time-consuming. Thus, in one embodiment, the combination index can be prepared to optimize searching and resource-use efficiency.

In one embodiment, such preparation of the combination index can occur whenever a part number is added, modified, or deleted, or on a scheduled interval. In one embodiment, the preparation can be performed once a night.

In one embodiment, such prepared combination index can optimize access to the database by being cached in local memory. To prepare such an index, queries can be made against the database to form all or selected searchable combinations.

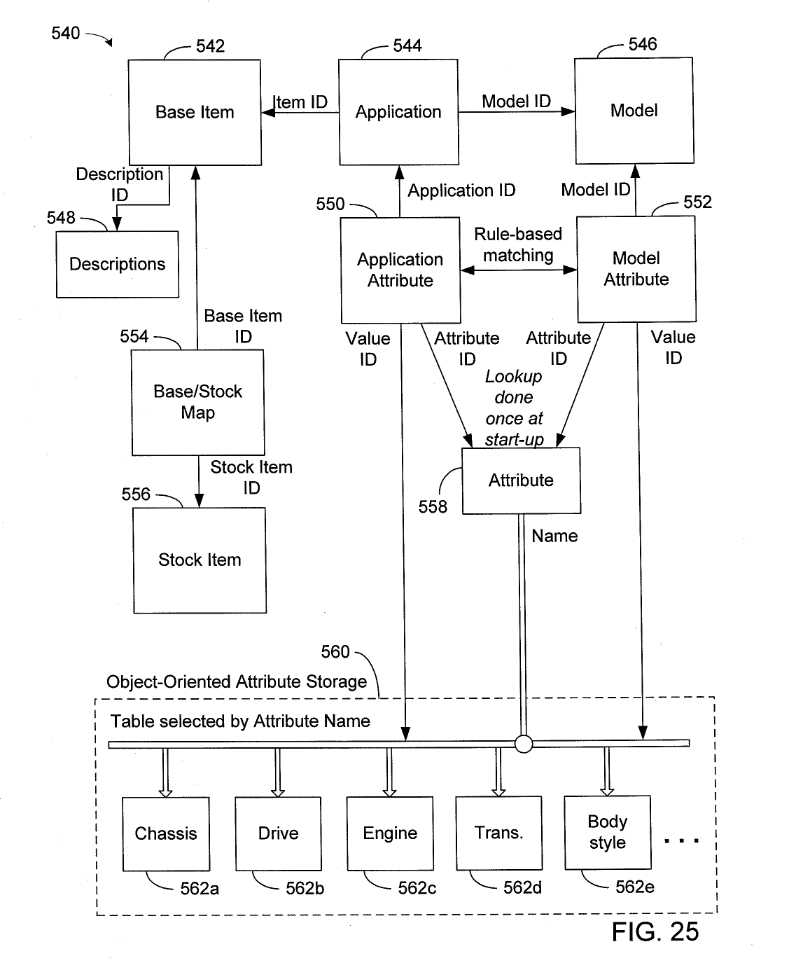

FIG. 25 shows one embodiment of an example configuration 540 of tables from which indices for searchable combinations can be formed. As shown, an Application table 544 can provide a mapping between base items (listed in a Base Item table 542) and models (listed in a Model table 546). In one embodiment, the Application table 544 can include Application-IDs corresponding to different Model-IDs, Base-item-IDs, Alternate-description-IDs, and Application-specific-comments.

In one embodiment, models (whose IDs are listed in the Model table 546) can have different Model attributes, and IDs to those attributes can be listed in a Model attribute table 552 as Attribute-IDs. In one embodiment, information about various Model attributes can be can be stored as and/or retrieved from an object-oriented attribute storage 560 via the corresponding Attribute-IDs. Examples of Model attributes 562 can include, but are not limited to, chassis, drivetrain, engine, transmission, body style, etc.

In one embodiment, an Application attribute table 550 can provide the Application-IDs to the Application table 544. The Application attribute table 550 can include a listing of Application-IDs corresponding to different Attribute-IDs and Model-IDs. As shown in FIG. 25, the Application attribute table 550 can have the same listing of the Attribute-IDs and Model-IDs as that of the Model attribute table 552. However, in certain situations, blocks of Attribute-IDs can have a common application. For example, in FIG. 16A, there was only one engine type for all of the “Honda Civic DX” models (for all the body styles and transmission types).

Thus, to reduce redundancies when forming the searchable Application-IDs, the relationship between the Application attributes table 550 and the Model attributes table 552 can be regulated by rule-based matching. Thus, for example, when the Application relates to “1992 Honda Civic DX,” the body style and transmission attribute IDs are excluded from searches, thereby reducing the number of possible combinations among the model and its attributes.

In one embodiment, as shown in FIG. 25, names associated with the attributes can be looked up and stored in an Attribute table 558. Such lookup can be conducted at start-up of the server, and both the Application attribute table 550 and the Model attribute table 552 can quickly retrieve the names given the Attribute-IDs.

As described above, the Application table 544 provides possible combinations of the Item-IDs with the attribute-regulated Model-IDs. FIG. 25 further shows that the Item-IDs can be listed in the Base item table 542. In one embodiment, the Item-IDs can be based on the automobile manufacturers' OEM part numbers so as to provide one set of unique numbers. As shown, the Base item table 542 can retrieve the descriptions for the Item-IDs from a Descriptions table 548.

For a given OEM part, there may be a number of aftermarket products, and such products can be assigned Stock-item-IDs. Such identifiers can be assigned by the vendors of the products, and/or by the maintainer of the database. In one embodiment, a Base/Stock map 554 provides mapping between the Stock-item-IDs listed in a Stock item table 556 with the Item-IDs, thereby providing a unique mapping for each of the supplied items in stock.

Based on the foregoing, one can see that the combination index can be formed to include substantially all of the possible combinations, to selected combinations, of the items and the various model attributes. As described above, the rule-based matching of the applications with the attributes can substantially reduce the number of combinations. The foregoing matching rule can be based on applications-based rules (for example, one engine possibility for the “1992 Honda Civic DX”), likelihood of search usage, etc. For example, if certain brands and models of automobiles occupy a significant portion of models, attributes, etc., with a minimal likelihood that the parts will be purchased online, such brands and models can be blocked from searches to significantly to reduce the number of combinations.

In general, it will be appreciated that the processors can include, by way of example, computers, program logic, or other substrate configurations representing data and instructions, which operate as described herein. In other embodiments, the processors can include controller circuitry, processor circuitry, processors, general purpose single-chip or multi-chip microprocessors, digital signal processors, embedded microprocessors, microcontrollers and the like.

Furthermore, it will be appreciated that in one embodiment, the program logic may advantageously be implemented as one or more components. The components may advantageously be configured to execute on one or more processors. The components include, but are not limited to, software or hardware components, modules such as software modules, object-oriented software components, class components and task components, processes methods, functions, attributes, procedures, subroutines, segments of program code, drivers, firmware, microcode, circuitry, data, databases, data structures, tables, arrays, and variables.

Although the above-disclosed embodiments have shown, described, and pointed out the fundamental novel features of the invention as applied to the above-disclosed embodiments, it should be understood that various omissions, substitutions, and changes in the form of the detail of the devices, systems, and/or methods shown may be made by those skilled in the art without departing from the scope of the invention. Consequently, the scope of the invention should not be limited to the foregoing description, but should be defined by the appended claims.

What is claimed is:

1. A method for searching an electronic catalog for automobile parts, the method comprising:
receiving a search request having one or more terms that describe or attempt to describe an automobile part;
comparing said one or more terms with a standard vocabulary; and
identifying one or more matched words, each of said one or more matched words being a part of said standard vocabulary and corresponding to at least one of said one or more terms, such that said one or more matched words are used for conducting a search for information about said automobile part in an electronic database.

2. The method of claim 1, further comprising identifying one or more part descriptions that include at least some of said one or more matched words.

3. The method of claim 2, wherein each of said one or more part descriptions includes all of said one or more matched words.

4. The method of claim 2, wherein said standard vocabulary is formed based on words from said part descriptions.

5. The method of claim 1, wherein said comparing comprises translating abbreviations, alternate nomenclatures, and misspellings to corresponding words prior to comparison with said standard vocabulary.

6. The method of claim 1, wherein said comparing comprises performing a look-ahead on said one or more terms to identify terms that should be treated together as a single term.

7. The method of claim 1, wherein every word in said standard vocabulary is substantially unique so as to reduce likelihood of said one or more matched words having more than one of same word.

8. The method of claim 1, wherein said identifying of one or more matched words further comprises obtaining identity or possible identities of said automobile so as to further narrow said search for information about said automobile part.

9. A system for searching an electronic catalog for automobile parts, the system comprising:
a standard vocabulary component having a plurality of standardized words with respect to information in an electronic database about parts for automobiles; and
a processor configured so as to:
receive a search request having one or more terms that describe or attempt to describe an automobile part;
compare said one or more terms with said plurality of standardized words; and
identify one or more matched words, each of said one or more matched words being a part of said plurality of standardized words and corresponding to at least one of said one or more terms, such that said one or more matched words are used for conducting a search for information about said automobile part in said electronic database.

10. The system of claim 9, wherein said standard vocabulary component and said processor reside on a server that is separate from electronic database, such that search queries sent to said electronic database are standardized and narrowed at said server to thereby make said search for information more efficient.

11. The system of claim 10, further comprising a description component having a plurality of automobile-parts descriptions that include substantially all of said one or more matched words.

12. The system of claim 11, wherein said plurality of standardized words are based on words from said automobile-parts descriptions.

13. The system of claim 12, wherein every one of said plurality of standardized words is substantially unique so as to reduce likelihood of said one or more matched words having more than one of same word.

14. The system of claim 11, further comprising an editor component configured so as to allow an editor to view taxonomical structure of selected one or more words found in said plurality of automobile-parts descriptions.

15. The system of claim 10, further comprising a translation component having common abbreviations, alternate nomenclatures, and misspellings so as to allow translations of said one or more terms.

16. The system of claim 10, wherein said standard vocabulary component comprises a first vocabulary for identifying models of automobiles, and a second vocabulary for identifying parts for automobiles.

17. The system of claim 16, wherein said first and second vocabularies are separate vocabularies.

18. The system of claim 17, wherein said first and second vocabularies reside in a local memory of a same server.

19. The system of claim 16, wherein said processor performs said identification separately for said automobile part and for the model corresponding to said automobile part.

20. A method for searching an electronic catalog for parts that depend on models of products, the method comprising:
receiving a search request having one or more terms that describe a model of a product and a part for said product;
determining which of said one or more terms are for describing said model, and which are for describing said part;
identifying one or more standardized words based on said model-terms;
identifying one or more standardized words based on said part-terms;
forming a search query based on said one or more standardized model-words and said one or more standardized part-words; and
transmitting said search query to an electronic database for conducting a search for information about said part for said product.

21. The method of claim 20, wherein said product comprises an automobile.

22. A system for searching an electronic catalog for parts that depend on models of products, the system comprising:
a first standard vocabulary having words for identifying product models;
a second standard vocabulary having words for identifying product parts;
a processor configured so as to:
receive a search request having one or more terms that describe a model of a product and a part for said product;
determine which of said one or more terms are for describing said model, and which are for describing said part;
identify one or more standardized words based on said model-terms;
identify one or more standardized words based on said part-terms;
form a search query based on said one or more standardized model-words and said one or more standardized part-words; and
transmit said search query to an electronic database for conducting a search for information about said part for said product.

23. The system of claim 22, wherein said product comprises an automobile.

24. An apparatus, comprising:
means for receiving a search request having one or more terms that describe or attempt to describe an automobile part;
means for comparing said one or more terms with a standard vocabulary; and
means for identifying one or more matched words, each of said one or more matched words being a part of said standard vocabulary and corresponding to at least one of said one or more terms, such that said one or more matched words are used for conducting a search for information about said automobile part in an electronic database.

25. An apparatus, comprising:
means for receiving a search request having one or more terms that describe a model of a product and a part for said product;
means for determining which of said one or more terms are for describing said model, and which are for describing said part;
means for identifying one or more standardized words based on said model-terms;
means for identifying one or more standardized words based on said part-terms;
means for forming a search query based on said one or more standardized model-words and said one or more standardized part-words; and
means for transmitting said search query to an electronic database for conducting a search for information about said part for said product.

26. A method for searching an electronic database for possible applications of automobile parts, the method comprising:
receiving a search request from a user;
forming a search query, said search query including a model identifier and one or more part identifiers;
determining possible applications by forming combinations of said one or more part identifiers with one or more attributes of said model identifier; and
providing said possible applications to said user.

27. The method of claim 26, wherein said possible applications includes at least one attribute that is not specified by said user.

28. A method for configuring a database server for an automobile parts catalog, the method comprising:
providing a list of identifiers for automobile parts;
providing a list of identifiers for attributes of automobile models;
forming an index of selected combinations of said identifiers for parts and attributes; and
providing said index on said database server so that said index provides addresses of database entries corresponding to said identifiers for parts or attributes.

29. The method of claim 28, wherein said selected combinations are determined based on a likelihood of a search for said parts or attributes.

30. The method of claim 28, wherein said selected combinations are formed by excluding redundancies of combinations of said parts and attributes.
